(19) United States
(12) Patent Application Publication
(10) Pub. No.: US 2022/0335727 A1
(43) Pub. Date: Oct. 20, 2022

(54) TARGET DETERMINATION METHOD AND APPARATUS, ELECTRONIC DEVICE, AND COMPUTER-READABLE STORAGE MEDIUM

(71) Applicants: TIANIIN SOTEREA AUTOMOTIVE TECHNOLOGY LIMITED COMPANY, Tianjin (CN); ZHEJIANG SOTEREA TECHNOLOGY GROUP LIMITED COMPANY, Hangzhou (CN)

(72) Inventors: Xianjie XU, Hangzhou (CN); Yanyan GAO, Tianjin (CN)

(73) Assignees: TIANIIN SOTEREA AUTOMOTIVE TECHNOLOGY LIMITED COMPANY, Tianjin (CN); ZHEJIANG SOTEREA TECHNOLOGY GROUP LIMITED COMPANY, Hangzhou (CN)

(21) Appl. No.: 17/811,078

(22) Filed: Jul. 7, 2022

Related U.S. Application Data
(63) Continuation of application No. PCT/CN2021/111922, filed on Aug. 11, 2021.

(30) Foreign Application Priority Data
Mar. 5, 2021 (CN) 202110242335.4

(51) Int. Cl. G06V 20/56; B60R 1/23; G06T 7/11; G06V 10/22

(52) U.S. Cl. CPC G06V 20/56; B60R 1/23; G06T 7/11; G06V 10/22; B60R 2300/802; G06T 2210/12

(57) ABSTRACT

A target determination method includes: acquiring a captured monitoring image, performing target detection on the monitoring image to obtain at least one initial target, determining in turn whether each initial target is a true target, and taking all true targets as final targets. The determination of target box parameters includes: determining a three-dimensional model of a target according to the target; moving the position of the three-dimensional model in a world coordinate system associated with image coordinates; and transforming the three-dimensional model in the position to an image coordinate system to obtain the target box parameters; Or, the determination of target box parameters includes: acquiring a historical monitoring image; performing target detection on the historical monitoring image to obtain a target box of the target; and determining the target box parameters according to the target box.

### CROSS-REFERENCE TO RELATED APPLICATIONS

This application is a continuation of International Patent Application No. PCT/CN2021/111922 with a filing date of Nov. 8, 2021, designating the United States, now pending, and further claims priority to Chinese Patent Application No. 202110242335.4 with a filing date of Mar. 5, 2021. The content of the aforementioned applications, including any intervening amendments thereto, are incorporated herein by reference.

### TECHNICAL FIELD

The present invention relates to computer vision processing technology, in particular to a target determination method and apparatus, an electronic device, and a computer-readable storage medium.

### DESCRIPTION OF RELATED ART

With the development of urban construction, large vehicles such as buses, tankers, and muck trucks have contributed to urban construction and also caused many unnecessary traffic accidents. Due to the high body of large vehicles, there is a large visual blind spot for the driver. In addition, the pedestrian target is relatively small, the driver cannot observe the pedestrian entering the blind spot, and especially when the vehicle turns, there is a great potential safety hazard.

At present, the picture in the blind spot is presented to the driver by installing a blind spot monitoring camera on a large vehicle, and an alarm is given when there is a pedestrian in the blind spot. However, the pedestrian identification method in the prior art cannot achieve 100% accuracy, and there will be misidentification of pedestrians. When a non-pedestrian target appears in the blind spot, an alarm is also given, resulting in a large number of false alarms, which seriously affects product performance and user experience.

### SUMMARY

The present invention provides a target determination method and apparatus, an electronic device, and a computer-readable storage medium, to filter out false targets in a blind spot, thereby reducing false alarm rate and improving product performance and user experience.

In a first aspect, an embodiment of the present invention provides a target determination method, which is applied to a blind spot monitoring system of a vehicle, and the method includes:

Step 11, acquiring a captured monitoring image;

Step 12, performing target detection on the monitoring image to obtain at least one initial target;

Step 13, performing the following operations on each of the initial targets in turn:

judging whether the initial target is in a blind spot of the monitoring image;

if so, obtaining, according to image coordinates of the initial target, target box parameters associated with the image coordinates;

comparing the target box parameters with the initial target box parameters;

determining, according to the comparison results, whether the initial target is a true target; and

Step 14, taking all true targets as final targets.

The determination of the target box parameters includes:

determining a three-dimensional model of the target according to the target;

moving the position of the three-dimensional model in a world coordinate system associated with the image coordinates; and

transforming the three-dimensional model in the position to an image coordinate system to obtain the target box parameters.

Or, the determination of the target box parameters includes:

acquiring a historical monitoring image;

performing target detection on the historical monitoring image to obtain a target box of the target; and

determining the target box parameters according to the target box.

In a second aspect, an embodiment of the present invention further provides a target determination apparatus, including:

an image acquisition module, configured to acquire a captured monitoring image;

a target detection module, configured to perform target detection on the monitoring image to obtain at least one initial target;

a target judgment module, configured to perform the following operations on each of the initial targets in turn:

judging whether the initial target is in a blind spot of the monitoring image;

if so, obtaining, according to image coordinates of the initial target, target box parameters associated with the image coordinates;

comparing the target box parameters with the initial target box parameters;

determining, according to the comparison results, whether the initial target is a true target; and

a target determination module, configured to take all true targets as final targets.

The determination of the target box parameters includes:

determining a three-dimensional model of the target according to the target;

moving the position of the three-dimensional model in a world coordinate system associated with the image coordinates; and

transforming the three-dimensional model in the position to an image coordinate system to obtain the target box parameters.

Or, the determination of the target box parameters includes:

acquiring a historical monitoring image;

performing target detection on the historical monitoring image to obtain a target box of the target; and

determining the target box parameters according to the target box.

In a third aspect, an embodiment of the present invention further provides an electronic device, the electronic device includes:

one or more processors; and

a storage apparatus, configured to store one or more programs.

When the one or more programs are executed by the one or more processors, the one or more processors implement the target determination method as described in the first aspect above.

In a fourth aspect, an embodiment of the present invention further provides a computer-readable storage medium, storing a computer program thereon. When the program is executed by a processor, the target determination method as described in the first aspect above is implemented.

According to the technical solution provided by the embodiments of the present invention, a captured monitoring image is acquired, target detection is performed on the monitoring image, at least one initial target is obtained, and the following operations are performed on each of the initial targets in turn: judging whether the initial target is in a blind spot of the monitoring image, if so, obtaining, according to image coordinates of the initial target, target box parameters associated with the image coordinates, comparing the target box parameters with the initial target box parameters, and determining, according to the comparison results, whether the initial target is a true target; and all true targets are taken as final targets. The determination of the target box parameters includes: determining a three-dimensional model of the target according to the target, moving the position of the three-dimensional model in a world coordinate system associated with the image coordinates, and transforming the three-dimensional model in the position to an image coordinate system to obtain the target box parameters. Or, the determination of the target box parameters includes: acquiring a historical monitoring image, performing target detection on the historical monitoring image to obtain a target box of the target, and determining the target box parameters according to the target box. Accordingly, false targets are filtered out, thereby reducing false alarm rate and improving product performance and user experience.

### BRIEF DESCRIPTION OF THE DRAWINGS

Other features, objectives and advantages of the present invention will become more apparent by reading the detailed description of non-limiting embodiments made with reference to the following accompanying drawings:

FIG. 1 is a schematic flowchart of a target determination method according to an embodiment of the present invention;

FIG. 2 is a schematic flowchart of a method for determining a three-dimensional model of a target according to an embodiment of the present invention;

FIG. 3 is a schematic flowchart of a method for determining a three-dimensional model of a target according to an embodiment of the present invention;

FIG. 4 is a schematic flowchart of a method for comparing target box parameters with corresponding initial target box parameters according to an embodiment of the present invention;

FIG. 5 is a schematic flowchart of a method for judging whether the initial target is in a blind spot of the monitoring image according to an embodiment of the present invention;

FIG. 6 is a blind spot image according to an embodiment of the present invention;

FIG. 7 is a schematic structural illustration of a target determination apparatus according to an embodiment of the present invention; and

FIG. 8 is a schematic structural illustration of an electronic device according to an embodiment of the present invention.

### DESCRIPTION OF THE EMBODIMENTS

In order to further illustrate the technical means adopted by the present invention to achieve the predetermined objectives of the invention and effects, the embodiments, structures, features and effects of a target determination method and apparatus, an electronic device, and a computer-readable storage medium provided by the present invention will be described in detail as follows in conjunction with the accompanying drawings and preferred embodiments.

An embodiment of the present invention provides a target determination method, applied to a blind spot monitoring system of a vehicle, the method includes:

Step 11, acquiring a captured monitoring image;

Step 12, performing target detection on the monitoring image to obtain at least one initial target;

Step 13, performing the following operations on each of the initial targets in turn:

judging whether the initial target is in a blind spot of the monitoring image;

if so, obtaining, according to image coordinates of the initial target, target box parameters associated with the image coordinates;

comparing the target box parameters with the initial target box parameters;

determining, according to the comparison results, whether the initial target is a true target; and

Step 14, taking all true targets as final targets.

The determination of the target box parameters includes:

determining a three-dimensional model of the target according to the target;

moving the position of the three-dimensional model in a world coordinate system associated with the image coordinates; and

transforming the three-dimensional model in the position to an image coordinate system to obtain the target box parameters.

Or, the determination of the target box parameters includes:

acquiring a historical monitoring image;

performing target detection on the historical monitoring image to obtain a target box of the target; and

determining the target box parameters according to the target box.

According to the technical solution provided by the embodiments of the present invention, a captured monitoring image is acquired, target detection is performed on the monitoring image, at least one initial target is obtained, and the following operations are performed on each of the initial targets in turn: judging whether the initial target is in a blind spot of the monitoring image, if so, obtaining, according to image coordinates of the initial target, target box parameters associated with the image coordinates, comparing the target box parameters with the initial target box parameters, and determining, according to the comparison results, whether the initial target is a true target; and all true targets are taken as final targets. The determination of the target box parameters includes: determining a three-dimensional model of the target according to the target, moving the position of the three-dimensional model in a world coordinate system associated with the image coordinates, and transforming the three-dimensional model in the position to an image coordinate system to obtain the target box parameters. Or, the determination of the target box parameters includes: acquiring a historical monitoring image, performing target detection on the historical monitoring image to obtain a target box of the target, and determining the target box parameters according to the target box. Accordingly, false targets are filtered out, thereby reducing false alarm rate and improving product performance and user experience.

The above is the core idea of the present application. The technical solution in the embodiments of the present invention will be clearly and completely described below in conjunction with the accompanying drawings in the embodiments of the present invention. Obviously, the described embodiments are only some of the embodiments of the present invention, not all of them. All other embodiments obtained by those of ordinary skill in the art based on the embodiments of the present invention without any creative efforts shall fall within the protection scope of the present invention.

Many specific details are set forth in the following description to facilitate a full understanding of the present invention, but the present invention can also be implemented in other embodiments different from those described herein, and those skilled in the art can do similar promotions without departing from the connotation of the present invention. Therefore, the present invention is not limited by the specific embodiments disclosed below.

Next, the present invention is described in detail with reference to the schematic illustrations. When the embodiments of the present invention are described in detail, for the convenience of explanation, the schematic illustrations showing the structures of devices are not partially enlarged according to the general scale, and the schematic illustrations are only examples and should not limit the protection scope of the present invention. In addition, the three-dimensional spatial dimensions including length, width and height should be included in the actual production.

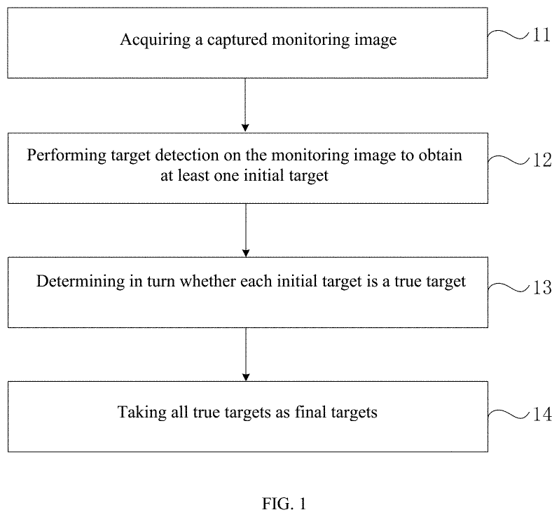

FIG. 1 is a schematic flowchart of a target determination method according to an embodiment of the present invention. The method of this embodiment may be executed by a target determination apparatus, which may be implemented by means of hardware and/or software, and may generally be integrated into a blind spot monitoring system of a vehicle to filter out false targets in a blind spot of the vehicle.

The target determination method provided in this embodiment is applied to a blind spot monitoring system of a vehicle. Specifically, as shown in FIG. 1, the method may include the following steps.

Step 11: Acquiring a captured monitoring image.

The monitoring image is an image captured by a blind spot monitoring camera to show a blind spot of the vehicle. It is understandable that, in addition to the blind spot of the vehicle, on the basis of different view finding ranges of the blind spot monitoring camera, the blind spot image further includes other scenario information, such as side walls of the vehicle and a pavement outside the blind spot. The target determination method provided in this embodiment is used to determine the authenticity of targets appearing in the blind spot and filter out false targets.

It is understandable that the main purpose of blind spot monitoring is to avoid the risk that pedestrians appearing in the blind spot are hit. Therefore, the blind spot monitoring focuses on persons. Persons are taken as true targets, and may specifically be walking passers-by or riders, etc. False targets are non-person objects, such as fire hydrants.

The monitoring image captured in real time is obtained from the blind spot monitoring camera by an electronic control unit of the vehicle.

Step 12: Performing target detection on the monitoring image to obtain at least one initial target.

This embodiment does not limit the specific method of target detection. The detection region is a complete monitoring image, and at least one initial target obtained is all targets in the monitoring image, which specifically includes the following three situations: 1. The at least one initial target is a false target(s); 2. The at least one initial target is a true target(s); and 3. The at least one initial target includes a false target(s) and a true target(s).

Exemplarily, the specific form of the initial target may be a rectangular box, and the corresponding detection process is: identifying the target in the monitoring image, and determining the rectangular box including the target and having the smallest size as the detected initial target.

Step 13: Determining in turn whether each initial target is a true target.

Optionally, the method of determining in turn whether each initial target is a true target includes: judging whether the initial target is in a blind spot of the monitoring image, if so, obtaining, according to image coordinates of the initial target, target box parameters associated with the image coordinates, comparing the target box parameters with the initial target box parameters, and determining, according to the comparison results, whether the initial target is a true target.

This embodiment focuses on persons who cannot be directly observed by the driver in the blind spot of the vehicle. Therefore, after each initial target in the monitoring image is obtained, whether the initial target is in a region of interest, that is, the blind spot of the vehicle, is first determined, and whether the initial target is a true target is further determined after it is determined that the initial target is in the blind spot of the vehicle.

Exemplarily, image coordinates of two vertices on a diagonal in the initial target in the form of a rectangular box can be directly obtained by detection, coordinates of other two vertices can be obtained by calculation on the basis of the image coordinates of the two vertices, the vertex closest to the vehicle in the distance monitoring image and the view finding position of the camera is determined as the image coordinates of the initial target, then the position of the image coordinates in an image coordinate system is obtained, and whether the initial target is in the blind spot is determined according to the relationship between the position and the blind spot. On the other hand, a plurality of target box parameters are pre-stored locally, and the relationship between the target box parameters and the image coordinates of the initial target is specifically as follows: the position of the initial target corresponding to the image coordinates in the blind spot is the same as the position of a target box corresponding to the target box parameters in the blind spot. On this basis, after it is determined that the initial target is in the blind spot, the associated target box parameters can be determined according to the position of the image coordinates of the initial target in the image coordinate system. It can be understood that, when there is a target box at the same position as the initial target, the target box parameters of the target box are the associated target box parameters, and when there is no target box at the same position as the initial target, the target box parameters of the target box closest to the initial target are the associated target box parameters. The target box parameters may be, for example, the length, width and width-to-length ratio of the target box.

When there are multiple types of target box parameters and initial target box parameters, the same type of target box parameters and initial target box parameters are compared respectively to determine the degree of matching between the target box parameters and the initial target box parameters.

The target box parameters are obtained on the basis of the true target, the degree of proximity between the initial target and the true target can be determined by determining the degree of matching, and then whether the initial target is a true target can be determined.

If the comparison result is that the initial target box parameters deviate far from the target box parameters, it indicates that the initial target is quite different from the true target, and the initial target is determined as a false target. If the comparison result is that the initial target box parameters are very similar to the target box parameters, the initial target is determined as a true target. This embodiment does not limit the specific way to determine the deviation between the initial target box parameters and the target box parameters. For example, an error range may be preset. When it is determined that the difference between the initial target box parameters and the target box parameters is within the preset error range, it is considered that the deviation of the two is small, otherwise the deviation is large.

Step 14: Taking all true targets as final targets. The determination of the target box parameters includes: determining a three-dimensional model of the target according to the target, moving the position of the three-dimensional model in a world coordinate system associated with the image coordinates, and transforming the three-dimensional model in the position to an image coordinate system to obtain the target box parameters. Or, the determination of the target box parameters includes: acquiring a historical monitoring image, performing target detection on the historical monitoring image to obtain a target box of the target, and determining the target box parameters according to the target box.

The final targets are targets used to activate a blind spot monitoring alarm prompt.

The true targets of the at least one initial target are determined as final targets, and are retained and applied to the later application of the blind spot monitoring system, while false targets are ignored, thereby filtering out the false targets and improving the probability that the targets applied in the blind spot monitoring system are true targets.

It should be noted that this embodiment provides two methods for determining target box parameters. The first method for determining target box parameters is described as follows: the target box is located under the image coordinates. In order to facilitate direct comparison between the initial targets in the image at different positions in the blind spot and the corresponding target boxes, the target boxes in the image at different positions in the blind spot are pre-determined to form a target box library corresponding to the same target. Specifically, in the actual scenario, the targets are all of three-dimensional structures. In this embodiment, a three-dimensional model of the target corresponding to the target box library is first determined, and then the position of the three-dimensional model of the target is moved in the three-dimensional scenario, that is, in the world coordinate system. The three-dimensional model is projected into the image coordinate system each time a position is moved, which is equivalent to a transformation of the actual scenario into a two-dimensional image captured by the camera. The above idea is used to obtain the target boxes in the blind spot image at different positions in the blind spot, and the target box parameters can be obtained by measurement or calculation.

More specifically, the transformation of the three-dimensional scenario into the two-dimensional image, that is, the transformation from world coordinates to image coordinates, is performed using the following Formula 1.

$${Z}_{c} ( \begin{matrix}u \\ v \\ 1\end{matrix} ) = ( \begin{matrix}\frac{1}{dx} & 0 & {u}_{0} \\ 0 & \frac{1}{dy} & {v}_{0} \\ 0 & 0 & 1\end{matrix} ) ( \begin{matrix}f & 0 & 0 \\ 0 & f & 0 \\ 0 & 0 & 1\end{matrix} ) ( \begin{matrix}R & T\end{matrix} ) ( \begin{matrix}{X}_{W} \\ {Y}_{W} \\ {Z}_{W} \\ 1\end{matrix} ) = ( \begin{matrix}{f}_{x} & 0 & {u}_{0} \\ 0 & {f}_{y} & {v}_{0} \\ 0 & 0 & 1\end{matrix} ) ( \begin{matrix}R & T\end{matrix} ) ( \begin{matrix}{X}_{W} \\ {Y}_{W} \\ {Z}_{W} \\ 1\end{matrix} ) = {M}_{1} {M}_{2} ( \begin{matrix}{X}_{W} \\ {Y}_{W} \\ {Z}_{W} \\ 1\end{matrix} ) \qquad Formula 1$$

$$M 1 = [ \begin{matrix}{f}_{x} & 0 & {u}_{0} \\ 0 & {f}_{y} & {v}_{0} \\ 0 & 0 & 1\end{matrix} ]$$

is an internal parameter matrix of the blind spot monitoring camera, fx and fy are focal lengths of the blind spot monitoring camera, u0 and v0 are main point coordinates of the blind spot monitoring camera, M2 is an external parameter of the blind spot monitoring camera, including a rotation matrix R and a translation matrix T, (Xw, Yw, Zw) are world coordinates, (u, v) are image coordinates, and (Xc, Yc, Zc) are coordinates of the blind spot monitoring camera.

Exemplarily, for the case where the three-dimensional model of a target is a cube, the method for obtaining a target box is specifically as follows: after the position of the three-dimensional model is moved in the world coordinate system, the world coordinates of 8 vertices of the three-dimensional model are determined, the 8 vertices are transformed to the image coordinate system by using the above Formula 1, the minimum value of the 8 image coordinates obtained is taken as the lower left corner of the corresponding target box (close to the vehicle and the vertex of the blind spot monitoring camera), and when the target box is a rectangle, the width BB WIDTH=max(x)−min(x), length BB_Height=max(y)−min(y), and width-length ratio Rate=BB WIDTH/BBHeight of the target box are determined, wherein max(x) is the maximum x coordinate among the 8 image coordinates, min(x) is the minimum x coordinate among the 8 image coordinates, max(y) is the maximum y coordinate among the 8 image coordinates, and min(y) is the minimum y coordinate among the 8 image coordinates. At this time, the width, length and width-length ratio of the target box are the target box parameters.

The second method for determining target box parameters is described as follows: during the daily driving of the vehicle, the blind spot monitoring camera captures multiple monitoring images in real time. When target box parameters are determined, the stored multiple historical monitoring images are extracted, targets in each monitoring image are identified respectively to obtain corresponding target boxes, and the target box parameters of the target boxes are recorded. In this way, on the basis of the randomness of targets appearing in the blind spot of the vehicle during the daily driving of the vehicle, target box parameters corresponding to the targets at different positions in the blind spot can be obtained.

According to the technical solution provided by this embodiment, a captured monitoring image is acquired, target detection is performed on the monitoring image, at least one initial target is obtained, and the following operations are performed on each of the initial targets in turn: judging whether the initial target is in a blind spot of the monitoring image, if so, obtaining, according to image coordinates of the initial target, target box parameters associated with the image coordinates, comparing the target box parameters with the initial target box parameters, and determining, according to the comparison results, whether the initial target is a true target; and all true targets are taken as final targets. The determination of the target box parameters includes: determining a three-dimensional model of the target according to the target, moving the position of the three-dimensional model in a world coordinate system associated with the image coordinates, and transforming the three-dimensional model in the position to an image coordinate system to obtain the target box parameters. Or, the determination of the target box parameters includes: acquiring a historical monitoring image, performing target detection on the historical monitoring image to obtain a target box of the target, and determining the target box parameters according to the target box. Accordingly, false targets are filtered out, thereby reducing false alarm rate and improving product performance and user experience.

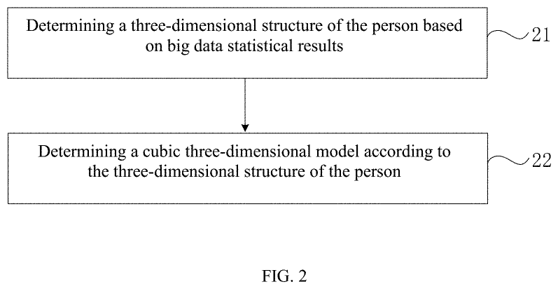

FIG. 2 is a schematic flowchart of a method for determining a three-dimensional model of a target according to an embodiment of the present invention. As shown in FIG. 2, if the target is a person, the steps of determining a three-dimensional model of the target may specifically include the following.

Step 21: Determining a three-dimensional structure of the person based on big data statistical results.

Exemplarily, in the big data statistics, the length, width, and height of persons are all normally distributed, the number of persons with length a, width b, and height d is the largest, and the three-dimensional structure is taken as the three-dimensional structure of a person. The three-dimensional structure here is understood as a model, and its outer contour is the shape of a person.

The determination of a fixed three-dimensional structure of persons is conducive to unifying the comparison standard, improving the realizability of comparison, and reducing the difficulty of comparison. In addition, the use of big data statistics to determine the three-dimensional structure of persons is conducive to increasing the similarity between the standard and the actual figures of most persons, reducing the preset error range, and improving the accuracy of comparison results.

Step 22: Determining a cubic three-dimensional model according to the three-dimensional structure of the person.

Specifically, the cube with the smallest volume including the three-dimensional structure of the person is determined as the three-dimensional model of the person. In this way, the three-dimensional structure with an irregular outer contour is approximated as a three-dimensional model with a regular structure, which is more convenient for coordinate transformation and relevant calculations.

Exemplarily, the dimensions of the three-dimensional model of the cube of the person may be, for example, 0.1 meter wide, 0.5 meter long, and 1.7 meters high.

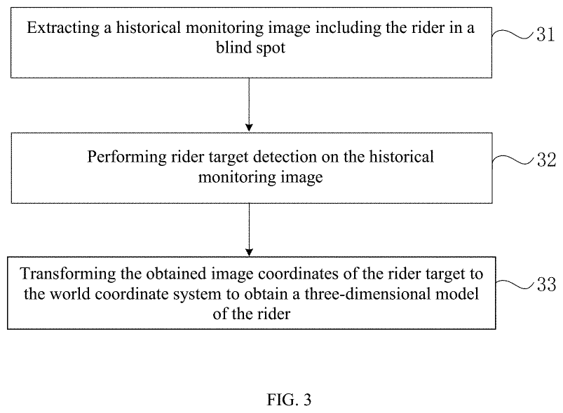

FIG. 3 is a schematic flowchart of a method for determining a three-dimensional model of a target according to an embodiment of the present invention. As shown in FIG. 3, if the target is a rider, the steps of determining the three-dimensional model of the target may specifically include the following.

Step 31: Extracting a historical monitoring image including the rider in a blind spot.

Specifically, the historical monitoring image is the one captured by the blind spot monitoring camera after the rider appears in the blind spot of the vehicle in the real scenario.

The rider is a person who rides, for example, a bicycle, a motorcycle, an electric vehicle or a tricycle. According to different vehicles, different riding postures, different positions relative to the blind spot monitoring camera, etc., the three-dimensional spaces of riders are quite different. In order to ensure the accuracy of comparison results, the riders with different three-dimensional spaces respectively form a set of corresponding target boxes, and a corresponding relationship is established with the image coordinates of corresponding initial targets. It can be understood that, when multiple sets of target boxes are pre-stored, for example, when there are three sets of target boxes: a target box of persons, a target box of riders who ride a bicycle, and a target box of riders who ride a tricycle are pre-stored, the relationship between image coordinates and target boxes further includes categories of targets, which may specifically be distinguished by different size ranges of different sets of target boxes.

Step 32: Performing rider target detection on the historical monitoring image.

The specific manner may refer to the foregoing detection process of initial targets, which will not be repeated here. It is worth noting that the detected target can be guaranteed to be a rider through the size range of the rider.

Step 33: Transforming the obtained image coordinates of the rider target to the world coordinate system to obtain a three-dimensional model of the rider.

The image coordinates are the coordinates in the image coordinate system, and the image coordinate system is a two-dimensional coordinate system. The world coordinate system is a world coordinate system associated with the above-mentioned image coordinate system, and is a three-dimensional coordinate system.

Exemplarily, the image coordinates of the rider in the historical monitoring image may be the image coordinates of four vertices in the smallest rectangular box demarcated on the basis of the rider's image. The following Formula 2 is used to realize the above-mentioned transformation of the image coordinates to the world coordinate system.

$$[ \begin{matrix}{X}_{W} \\ {Y}_{W} \\ {Z}_{W}\end{matrix} ] = {R}^{- 1} ( {Z}_{c} * {M}_{1}^{- 1} * [ \begin{matrix}u \\ v \\ 1\end{matrix} ] - T ) \qquad Formula 2$$

$$M 1 = [ \begin{matrix}{f}_{x} & 0 & {u}_{0} \\ 0 & {f}_{y} & {v}_{0} \\ 0 & 0 & 1\end{matrix} ]$$

is an internal parameter matrix of the blind spot monitoring camera, R is a rotation matrix, T is a translation matrix, (Xw, Yw, Zw) are world coordinates, (u, v) are image coordinates, (Xc, Yc, Zc) are coordinates of the blind spot monitoring camera.

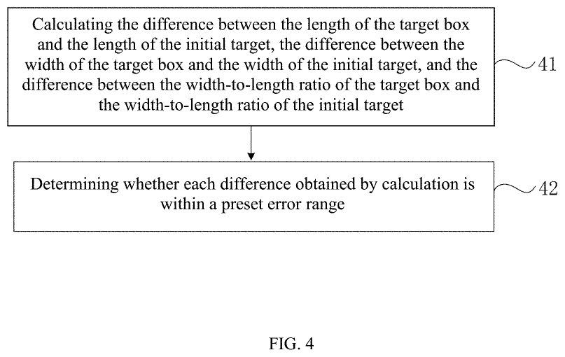

FIG. 4 is a schematic flowchart of a method for comparing target box parameters with corresponding initial target box parameters according to an embodiment of the present invention. As shown in FIG. 4, the comparison of the target box parameters with the corresponding initial target box parameters may specifically include the following.

Step 41: Calculating the difference between the length of the target box and the length of the initial target, the difference between the width of the target box and the width of the initial target, and the difference between the width-to-length ratio of the target box and the width-to-length ratio of the initial target.

In this embodiment, the target box parameters include the length, width, and width-length ratio of the target box, and the initial target box parameters include the length, width, and width-length ratio of the initial target. Based on the principle of comparing the same type of parameters respectively, the length of the target box and the length of the initial target, the width of the target box and the width of the initial target, as well as the width-to-length ratio of the target box and the width-to-length ratio of the initial target are compared respectively.

It can be understood that, in this embodiment, the target box and the initial target are both rectangles. By comparing the length, width, and width-to-length ratio respectively, the degree of matching between the target box and the initial target can be quickly and accurately determined in a numerical manner, with few calculation data, low calculation difficulty, and high accuracy of calculation results.

Step 42: Determining whether each difference obtained by calculation is within a preset error range.

The preset error range may be obtained by the statistics of multiple experimental results, or may be determined by the designer based on experience, etc., which is not limited in this embodiment. Any method that can determine a relatively accurate degree of matching falls within the protection scope of this embodiment.

In addition, the preset error ranges corresponding to different parameters may be the same or different, which is not limited in this embodiment.

It can be understood that, if each difference is within the preset error range, it indicates that the degree of matching between the initial target and the target box is high, and the initial target is determined as a true target. If there is at least one difference no longer within the preset error range, it indicates that the degree of matching between the initial target and the target box is low, and the initial target is determined as a false target.

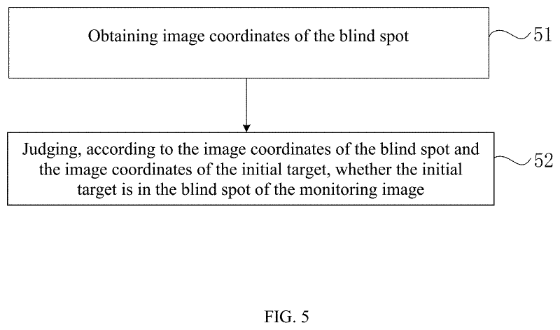

FIG. 5 is a schematic flowchart of a method for judging whether the initial target is in a blind spot of the monitoring image according to an embodiment of the present invention. As shown in FIG. 5, judging whether the initial target is in a blind spot of the monitoring image may include the following.

Step 51: Obtaining image coordinates of the blind spot.

Optionally, obtaining the image coordinates of the blind spot may include: determining the position of the blind spot in the world coordinate system associated with the image coordinates, and transforming the position to the image coordinate system, to obtain the image coordinates of the blind spot.

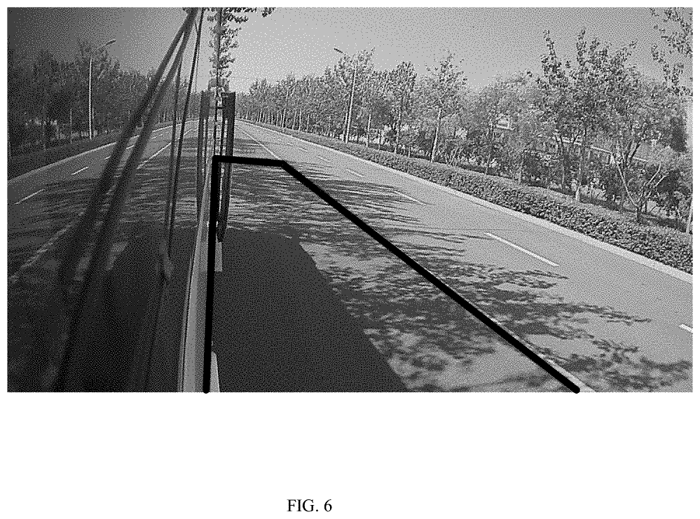

Exemplarily, in the practical scenario of a vehicle, the blind spot of the vehicle is fixed, for example, a rectangular region having a length of 15 meters and a width of 4 meters. Four vertices of the blind spot in the world coordinate system in the three-dimensional scenario are respectively transformed to the associated image coordinate system by using the aforementioned Formula 1 to obtain image coordinates of the four vertices of the blind spot in the monitoring image, and the blind spot is determined on the basis of the four vertices. FIG. 6 is a blind spot image according to an embodiment of the present invention. FIG. 6 specifically illustrates the position of the blind spot by using a bold solid line box.

Step 52: Judging, according to the image coordinates of the blind spot and the image coordinates of the initial target, whether the initial target is in the blind spot of the monitoring image.

After the blind spot in the monitoring image is determined in Step 51 above, an image coordinate range of all points in the blind spot can be determined, then the image coordinates of the initial target are determined to be within the coordinate range, and the initial target is determined to be in the blind spot of the monitoring image, otherwise, the initial target is not in the blind spot.

Optionally, moving the position of the three-dimensional model in a world coordinate system associated with the image coordinates may include: moving the position of the three-dimensional model in the world coordinate system associated with the image coordinates at a fixed distance interval in a line-by-line scanning manner.

Exemplarily, in the practical scenario of the vehicle, the blind spot of the vehicle is a rectangular region having a length of 15 meters and a width of 4 meters. The vertex of the rectangular region close to the vehicle and the blind spot monitoring camera is taken as the origin, the width is the x-axis, the length is the y-axis, and 1 meter is a unit length, that is, the fixed distance is 1 meter. The three-dimensional model is sequentially moved to (1,1) point, (2,1) point, (3,1) point, (4,1) point, (1,1) point, (1,2) point, (2,2) point, (3,2) point, (4,2) point . . . More specifically, in a three-dimensional scenario, the three-dimensional model is close to the vehicle and the blind spot monitoring camera, the position of the vertex in contact with the ground is determined as the position of the three-dimensional model, and the vertex is moved to the above-mentioned points, that is, the three-dimensional model is moved to the above-mentioned points.

This embodiment does not specifically limit the origins of the image coordinate system and the world coordinate system, and the origins can be reasonably set according to specific needs.

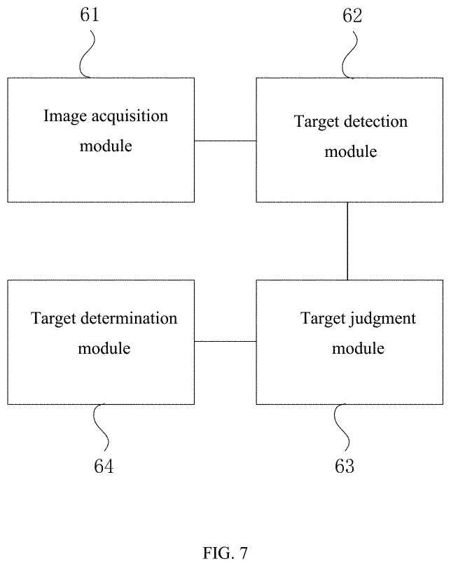

FIG. 7 is a schematic structural illustration of a target determination apparatus according to an embodiment of the present invention. As shown in FIG. 7, the target determination apparatus may specifically include:

an image acquisition module 61, configured to acquire a captured monitoring image;

a target detection module 62, configured to perform target detection on the monitoring image to obtain at least one initial target;

a target judgment module 63, configured to perform the following operations on each of the initial targets in turn:

judging whether the initial target is in a blind spot of the monitoring image;

if so, obtaining, according to image coordinates of the initial target, target box parameters associated with the image coordinates;

comparing the target box parameters with the initial target box parameters;

determining, according to the comparison results, whether the initial target is a true target; and

a target determination module 64, configured to take all true targets as final targets.

The determination of the target box parameters includes:

determining a three-dimensional model of the target according to the target;

moving the position of the three-dimensional model in a world coordinate system associated with the image coordinates; and

transforming the three-dimensional model in the position to an image coordinate system to obtain the target box parameters.

Or, the determination of the target box parameters includes:

acquiring a historical monitoring image;

performing target detection on the historical monitoring image to obtain a target box of the target; and

determining the target box parameters according to the target box.

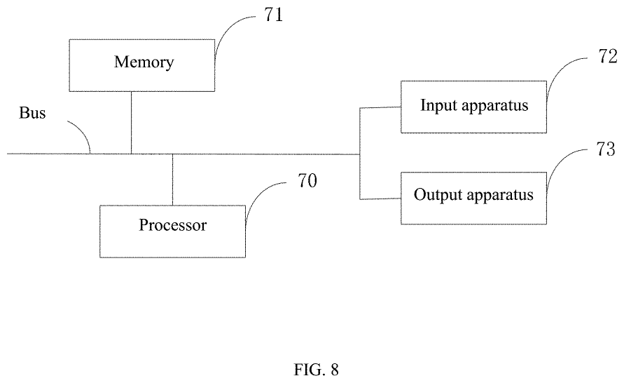

FIG. 8 is a schematic structural illustration of an electronic device according to an embodiment of the present invention. As shown in FIG. 8, the electronic device includes a processor 70, a memory 71, an input apparatus 72 and an output apparatus 73; The number of processors 70 in the electronic device may be one or more. One processor 70 is taken as an example in FIG. 8. The processor 70, the memory 71, the input apparatus 72 and the output apparatus 73 in the electronic device may be connected by a bus or in other ways, and they are for example, connected by a bus in FIG. 8.

As a computer-readable storage medium, the memory 71 may be configured to store software programs, computer-executable programs and modules, such as program instructions/modules corresponding to the target determination method in the embodiment of the present invention (for example, the image acquisition module 61, target detection module 62, target judgment module 63 and target determination module 64 included in the target determination apparatus). The processor 70 executes various functional applications and data processing of the electronic device by running the software programs, instructions and modules stored in the memory 71, to implement the above-mentioned target determination method.

The memory 71 may mainly include a storage program region and a storage data region. The storage program region may store an operating system, and an application program required for at least one function; The storage data region may store data created according to the use of a terminal, etc. In addition, the memory 71 may include a high speed random access memory, and may also include a non-volatile memory, such as at least one magnetic disk storage device, a flash memory, or other non-volatile solid-state storage device. In some examples, the memory 71 may further include memories arranged remotely from the processor 70, and these remote memories may be connected to the electronic device through a network. Examples of the network include, but are not limited to, the Internet, an intranet, a local area network, a mobile communications network, or a combination thereof.

The input apparatus 72 may be configured to receive input digit or character information, and generate key signal input related to user settings and function control of the electronic device. The output apparatus 73 may include a display device such as a display screen.

An embodiment of the present invention further provides a storage medium including computer-executable instructions. The computer-executable instructions are used to execute a target determination method when executed by a computer processor, the method includes:

Step 11, acquiring a captured monitoring image;

Step 12, performing target detection on the monitoring image to obtain at least one initial target;

Step 13, performing the following operations on each of the initial targets in turn:

judging whether the initial target is in a blind spot of the monitoring image;

if so, obtaining, according to image coordinates of the initial target, target box parameters associated with the image coordinates;

comparing the target box parameters with the initial target box parameters;

determining, according to the comparison results, whether the initial target is a true target; and

Step 14, taking all true targets as final targets.

The determination of the target box parameters includes:

determining a three-dimensional model of the target according to the target;

moving the position of the three-dimensional model in a world coordinate system associated with the image coordinates; and

transforming the three-dimensional model in the position to an image coordinate system to obtain the target box parameters.

Or, the determination of the target box parameters includes:

acquiring a historical monitoring image;

performing target detection on the historical monitoring image to obtain a target box of the target; and

determining the target box parameters according to the target box.

Of course, the computer-executable instructions included in the storage medium provided by the embodiment of the present invention are not limited to the above-mentioned method operations, but can also execute relevant operations in the target determination method provided by any embodiment of the present invention.

From the above description of the embodiments, those skilled in the art can clearly understand that the present invention can be implemented by means of software and necessary general-purpose hardware, and of course can also be implemented by hardware, but in many cases the former is better. Based on such an understanding, the technical solution of the present invention substantially, or the part of the present invention making contribution to the prior art may be embodied in the form of a software product, and the computer software product may be stored in a computer-readable storage medium, such as a floppy disk of a computer, a Read-Only Memory (ROM), a Random Access Memory (RAM), a FLASH, a hard disk or a CD, including a number of instructions enabling a computer device (which may be a personal computer, a server, or a network communication device) to execute the method described in each embodiment of the present invention.

It is worth noting that, in the above-mentioned embodiment of the target determination apparatus, the units and modules included are only divided according to functional logics, but are not limited to the above-mentioned division, as long as the corresponding functions can be realized. In addition, the specific names of the functional units are only for the convenience of distinguishing from each other, and are not used to limit the protection scope of the present invention.

It should be noted that the above are only preferred embodiments of the present invention and applied technical principles. Those skilled in the art will understand that the present invention is not limited to the specific embodiments described herein, and various obvious changes, readjustments and substitutions can be made by those skilled in the art without departing from the protection scope of the present invention. Therefore, although the present invention is described in detail through the above embodiments, the present invention is not limited to the above embodiments, and can further include more other equivalent embodiments without departing from the concept of the present invention. The scope of the present invention is determined by the scope of the appended claims.

What is claimed is:

1. A target determination method, applied to a blind spot monitoring system of a vehicle, wherein the method comprises:
Step 11, acquiring a captured monitoring image;
Step 12, performing target detection on the monitoring image to obtain at least one initial target, a specific form of the initial target is a rectangular box;
Step 13, performing the following operations on each of the at least one initial target in turn:
judging whether the initial target is in a blind spot of the monitoring image;
if so, obtaining, according to image coordinates of the initial target, target box parameters associated with the image coordinates;
comparing the target box parameters with initial target box parameters, the initial target box parameters are parameters of the rectangular box;
determining, according to the comparison results, whether the initial target is a true target; and
Step 14, taking all true targets as final targets;
wherein, the determination of the target box parameters comprises:
determining a three-dimensional model of the target according to the target;
moving the position of the three-dimensional model in a world coordinate system associated with the image coordinates; and
transforming the three-dimensional model in the position to an image coordinate system to obtain the target box parameters;
Or, the determination of the target box parameters comprises:
acquiring a historical monitoring image;
performing target detection on the historical monitoring image to obtain a target box of the target; and
determining the target box parameters according to the target box;
a relationship between the target box parameters and the image coordinates of the initial target is specifically as follows: a position of the initial target corresponding to the image coordinates in the blind spot is the same as a position of a target box corresponding to the target box parameters in the blind spot.

2. The target determination method according to claim 1, wherein if the target is a person, the determining a three-dimensional model of the target comprises:
determining a three-dimensional structure of the person based on big data statistical results; and
determining a cubic three-dimensional model according to the three-dimensional structure of the person.

3. The target determination method according to claim 1, wherein if the target is a rider, the determining a three-dimensional model of the target comprises:
extracting a historical monitoring image comprising the rider in the blind spot;
performing rider target detection on the historical monitoring image; and
transforming the obtained image coordinates of the rider target to the world coordinate system to obtain a three-dimensional model of the rider.

4. The target determination method according to claim 1, wherein comparing the target box parameters with corresponding initial target box parameters comprises:
calculating the difference between the length of the target box and the length of the initial target, the difference between the width of the target box and the width of the initial target, and the difference between the width-to-length ratio of the target box and the width-to-length ratio of the initial target; and
judging whether each difference obtained by calculation is within a preset error range.

5. The target determination method according to claim 1, wherein judging whether the initial target is in a blind spot of the monitoring image comprises:
obtaining image coordinates of the blind spot; and
judging, according to the image coordinates of the blind spot and the image coordinates of the initial target, whether the initial target is in the blind spot of the monitoring image.

6. The target determination method according to claim 5, wherein obtaining the image coordinates of the blind spot comprises:
determining the position of the blind spot in the world coordinate system associated with the image coordinates; and
transforming the position to the image coordinate system to obtain the image coordinates of the blind spot.

7. The target determination method according to claim 1, wherein moving the position of the three-dimensional model in the world coordinate system associated with the image coordinates comprises:
moving the position of the three-dimensional model in the world coordinate system associated with the image coordinates at a fixed distance interval in a line-by-line scanning manner.

8. A target determination apparatus, comprising:
an image acquisition module, configured to acquire a captured monitoring image;
a target detection module, configured to perform target detection on the monitoring image to obtain at least one initial target, a specific form of the initial target being a rectangular box;
a target judgment module, configured to perform the following operations on each of the at least one initial target in turn:
judging whether the initial target is in a blind spot of the monitoring image;
if so, obtaining, according to image coordinates of the initial target, target box parameters associated with the image coordinates;
comparing the target box parameters with initial target box parameters, the initial target box parameters being parameters of the rectangular box;
determining, according to the comparison results, whether the initial target is a true target; and
a target determination module, configured to take all true targets as final targets.
wherein, the determination of the target box parameters comprises:
determining a three-dimensional model of the target according to the target;
moving a position of the three-dimensional model in a world coordinate system associated with the image coordinates; and
transforming the three-dimensional model in the position to an image coordinate system to obtain the target box parameters;
or, the determination of the target box parameters comprises:
acquiring a historical monitoring image;
performing target detection on the historical monitoring image to obtain a target box of the target; and
determining the target box parameters according to the target box.

9. An electronic device, comprising:
one or more processors; and
a storage apparatus, configured to store one or more programs,
wherein the one or more programs, when executed by the one or more processors, cause the one or more processors to implement the target determination method according to claim 1.

10. A computer-readable storage medium, storing a computer program thereon, wherein when the program is executed by a processor, the target determination method according to claim 1 is implemented.
